(19) United States
(12) Patent Application Publication
(10) Pub. No.: US 2011/0209629 A1
(43) Pub. Date: Sep. 1, 2011

(54) CONVEYOR OVEN AND METHOD FOR EASY ACCESS FOR MAINTENANCE

(75) Inventor: Jason Edward Lauer, Fort Wayne, IN (US)

(73) Assignee: MERCO/SAVORY LLC

(21) Appl. No.: 13/035,058

(22) Filed: Feb. 25, 2011

Related U.S. Application Data
(60) Provisional application No. 61/308,605, filed on Feb. 26, 2010.

(51) Int. Cl. A47J 37/00; A21B 1/48; B23P 11/00

(52) U.S. Cl. 99/443 C; 29/426.1

(57) ABSTRACT

A conveyor oven and method with enhanced serviceability. The conveyor oven has a top portion that is pivotally affixed to a base portion so that the top portion can be titled rearwardly during servicing, thereby exposing the conveyor oven's components for service. Also, a hinged crumb tray assists in maintaining the integrity of the oven and avoiding fire, smoke or undesirable smells during operation of the oven.

### RELATED APPLICATION

This application claims the priority of U.S. Provisional Application Ser. No. 61/308,605, filed Feb. 26, 2010, the entire contents of which are incorporated herein by reference.

### BACKGROUND

1. Field of the Disclosure

The present disclosure relates generally to a conveyor oven and method for easy access for maintenance in a small or very confined footprint area.

2. Description of Related Art

Space is essential in a restaurant and is typically very limited. The foodservice equipment does not always have room to operate or use all of its features due to limited footprint allowance for such foodservice equipment, especially in pre-existing restaurants.

That is, space is very valuable in a make line at a restaurant, so much so that it could determine if the restaurant buys a new piece of equipment. Since this space is so valuable there is not going to be enough room to service the piece of equipment where it is located within the restaurant. As such, many service providers are required to remove the equipment from it location on the make line in order to service it. This results in additional downtime during servicing and requires additional servicemen, since equipment often requires more than one service person to remove from its location due to size and weight.

Another service problem arises in the case of a crumb tray. If not timely serviced and left in a conveyor oven too long, unwanted smells and reduction in performance of the conveyor oven can result. Removal of crumb trays from conveyor ovens is usually extremely difficult because restaurants typically only provide enough make line space for an oven and provides no additional space to allow for ready removal of a conventional crumb tray. That is, if the oven is 30 inches long and is disposed within a 32 inch space, there is not much room for accessories, like a crumb tray, to slide in and out of the piece of equipment.

Accordingly, there is a need for a conveyor oven and method that allows for servicing and maintenance in place within a restaurant's make line.

### SUMMARY OF THE DISCLOSURE

In an embodiment of the conveyor oven of the present disclosure, the conveyor oven comprises a housing defining an oven chamber. A conveyor extends through the inlet into the oven chamber. The conveyor comprises a conveyor belt driven to transport food product into the oven chamber. A member is configured with the housing and is rotatable about a pivot to provide access for maintenance.

In another embodiment of the conveyor oven of the present disclosure, the member is selected from the group consisting of: a crumb tray and a bottom portion.

In another embodiment of the conveyor oven of the present disclosure, the crumb tray comprises a first flat portion and a second flat portion that are rotatable about the pivot.

In another embodiment of the conveyor oven of the present disclosure, the first flat portion and the second flat portion are co-planar when the crumb tray is fully installed in the housing. The crumb tray further comprises a handle extending from the first flat portion to assist in removal and installation of the crumb tray in the housing by rotation about the pivot of the first flat portion away from or toward the second flat portion.

In another embodiment of the conveyor oven of the present disclosure, the crumb tray further comprises a hinge assembly attached to the first and second flat portions for rotation about the pivot.

In another embodiment of the conveyor oven of the present disclosure, the housing comprises a slot and a tray support. The crumb tray is configured with the housing via the slot and the tray support.

In another embodiment of the conveyor oven of the present disclosure, the bottom portion is attached to the housing at the pivot so that either the housing or the bottom portion can be rotated about the pivot between a closed position and an access position. The housing and bottom portion are flush with one another in the closed position and are apart from one another in the access position.

In another embodiment of the conveyor oven of the present disclosure, a hinge assembly is attached to the housing and the bottom portion for rotation about the pivot.

In another embodiment of the conveyor oven of the present disclosure, parts that require maintenance are disposed in the bottom portion.

In an embodiment of a method of the present disclosure, the method comprises providing a housing defining an oven chamber in the conveyor oven and at least one member of the conveyor oven that is configured with the housing and rotating at least one of the member and the housing about a pivot to provide access for maintenance.

In another embodiment of the method of the present disclosure, the member is selected from the group consisting of: a crumb tray and a bottom portion.

In another embodiment of the method of the present disclosure, the crumb tray comprises a first flat portion and a second flat portion that are rotatable about the pivot.

In another embodiment of the method of the present disclosure, the first flat portion and the second flat portion are co-planar when the crumb tray is fully installed in the housing. A handle extends from the first flat portion to assist in removal and installation of the crumb tray in the housing by rotation about the pivot of the first flat portion away from or toward the second flat portion.

In another embodiment of the method of the present disclosure, the crumb tray further comprises a hinge assembly attached to the first and second flat portions for rotation about the pivot.

In another embodiment of the method of the present disclosure, the housing comprises a slot and a tray support. The crumb tray is configured with the housing via the slot and the tray support.

In another embodiment of the method of the present disclosure, the bottom portion is attached to the housing at the pivot so that either the housing or the bottom portion can be rotated about the pivot between a closed position and an access position. The housing and bottom portion are flush with one another in the closed position and are apart from one another in the access position.

In another embodiment of the method of the present disclosure, a hinge assembly is attached to the housing and the bottom portion for rotation about the pivot.

In another embodiment of the method of the present disclosure, parts that require maintenance are disposed in the bottom portion.

The above-described and other advantages and features of the present disclosure will be appreciated and understood by those skilled in the art from the following detailed description and drawings.

### BRIEF DESCRIPTION OF THE DRAWINGS

FIG. 1 is a top side perspective view of a conveyor oven according to the present disclosure.

FIG. 2 is a schematic top view of the conveyor oven of FIG. 1.

FIG. 3 is a schematic side view of the conveyor oven of FIG. 1.

FIG. 4 is a schematic front view of the conveyor oven of FIG. 1.

FIG. 5 is a bottom side perspective view of the conveyor oven of FIG. 1 with the top portion tilted open to allow for cleaning of the components in a bottom compartment thereof.

FIG. 6 is a bottom front perspective view of the conveyor oven of FIG. 1 tilted open.

FIG. 7 is a schematic top side perspective view of the conveyor oven of FIG. 1 having a first side wall removed.

FIG. 8 is a schematic top side perspective view of the conveyor oven of FIG. 1 having a second side wall removed.

FIG. 9 is a schematic exploded view of the conveyor oven of FIG. 1.

FIG. 10 is a schematic front right side partial perspective view of the conveyor oven of FIG. 1.

FIG. 11 is a schematic rear left side perspective view of the conveyor oven of FIG. 1.

FIG. 12 is a schematic top left side perspective view of the hinged crumb tray of the conveyor oven of FIG. 1.

FIG. 13 is a schematic left planar view of the conveyor oven of FIG. 1.

### DETAILED DESCRIPTION OF THE PREFERRED EMBODIMENT

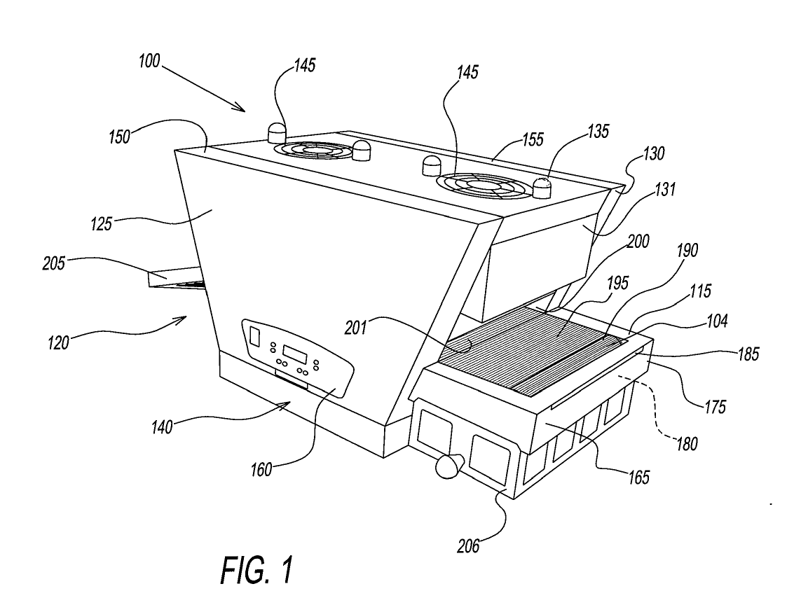

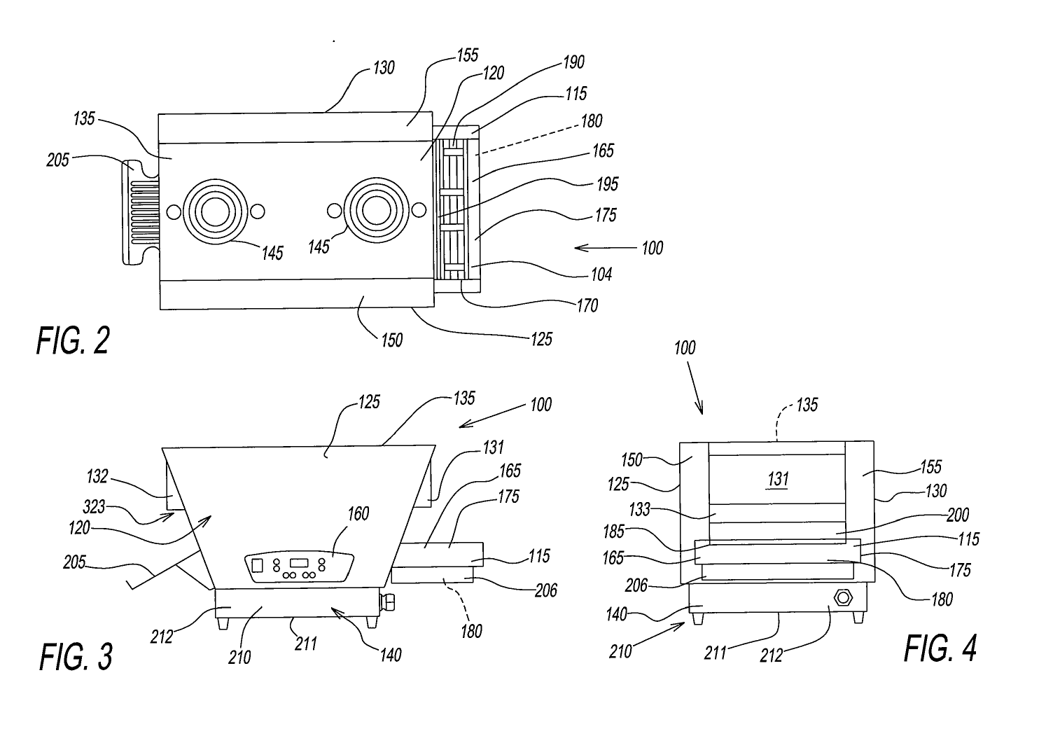

Referring to the drawings and in particular to FIGS. 1-4, an exemplary embodiment of a conveyor oven according to the present disclosure is generally referred to by reference numeral 100. Conveyor oven 100 comprises a conveyor 104, a housing 120 and a conveyor frame 115. Housing 120 has a first side wall 125, a second side wall 130, a first front wall 131, a rear wall 132, a second front wall 133, a bottom wall 225 and a top wall 135 that define an oven cavity or oven chamber 200 having an inlet 201 and an outlet 323. Housing 120 is connected to a bottom compartment 140. Top wall 135 has apertures 145. First side wall 125 covers a first compartment or side wall passage 150. Second side wall 130 covers a second compartment or side wall passage 155. A user interface 160 is disposed on first side wall 125. A user can use user interface 160 to enter data for cooking instructions or other data for conveyor oven 100. Conveyor 104 comprises a conveyor belt 195 that extends through inlet 201 into oven chamber 200 and is supported by housing 120. Conveyor frame 115 surrounds at least a portion of conveyor belt 195 that is outside inlet 201.

Conveyor frame 115 is hollow as defined by an outer wall assembly 165 and an inner wall assembly 170 that form a frame compartment or passage 175 having an interior volume 180 therebetween. Outer wall assembly 165 has apertures 185 therethrough allowing fluid communication between interior volume 180 and an ambient environment surrounding conveyor frame 115. Inner wall assembly 170 is connected to a drive shaft assembly 190, which moves conveyor belt 195. Food is placed on conveyor belt 195 by a user so that conveyor belt 195 moves the food from a position within conveyor frame 115 through oven chamber 200 to a rear tray 205. Conveyor frame 115 may be connected above an external crumb tray 206 that collects any loose debris or particles from conveyor belt 195 due to the user placing food product on conveyor belt 195.

Referring now to FIGS. 3-6, bottom compartment 140 comprises a bottom housing 210 with a base wall 211 and a base side wall 212 forming a bottom interior volume 215 that houses a fan 220. When bottom compartment 140 is connected to housing 120, interior volume 215 is covered by a bottom wall 225 of housing 120 and a first bottom side wall 230 of first compartment 150 and a second bottom side wall 235 of second compartment 155. First bottom side wall 230 has apertures 240 therethrough and second bottom side wall 235 has apertures 245 therethrough to provide fluid communication between interior volume 215 and side wall compartments 150 and 155.

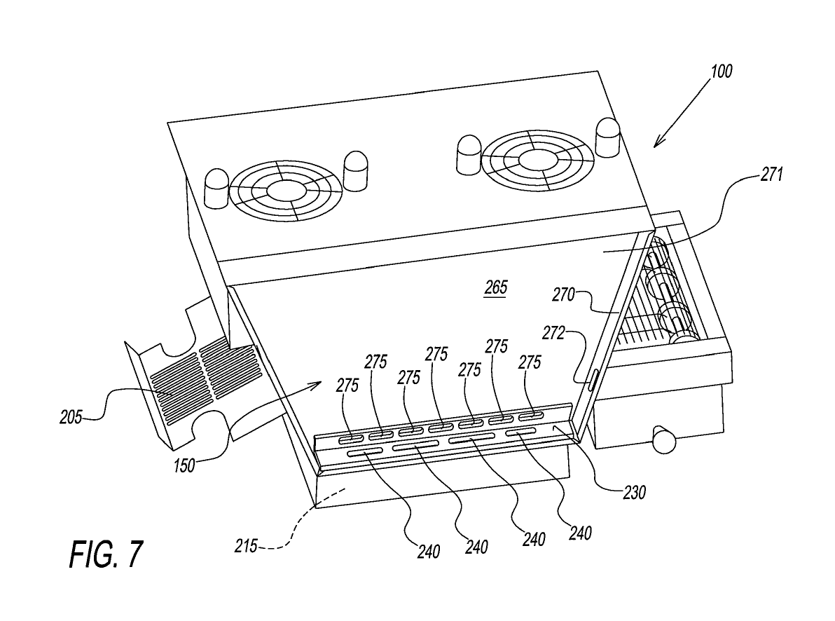

Referring now to FIG. 7, first compartment 150 has a first back panel 265 surrounded by a first compartment side wall 270 forming a first compartment interior 271. First back panel 265 has apertures 275 therethrough adjacent an edge that connects to first bottom side wall 230. First compartment side wall 270 has an aperture 272 therethrough from first compartment interior 271 to interior volume 180 in conveyor frame 115.

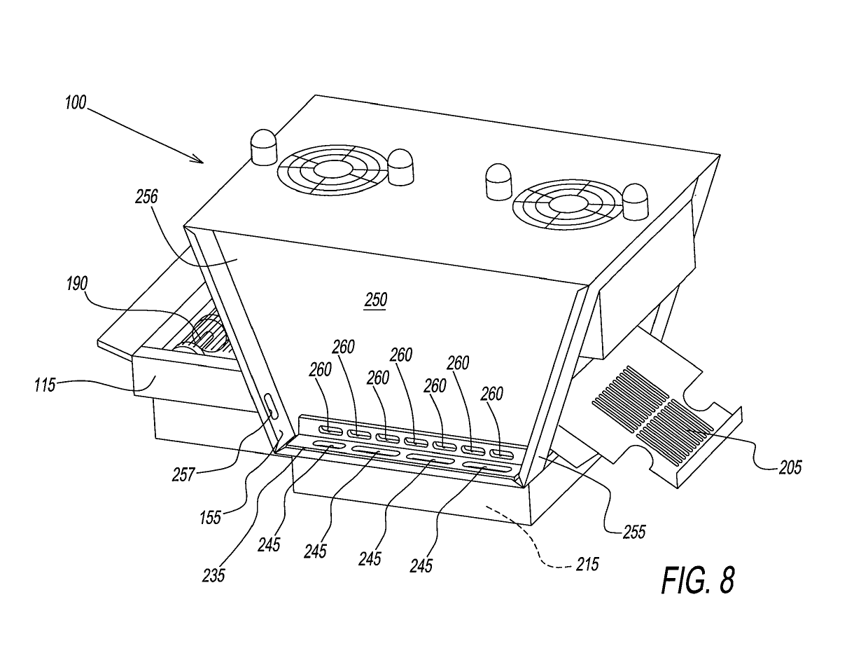

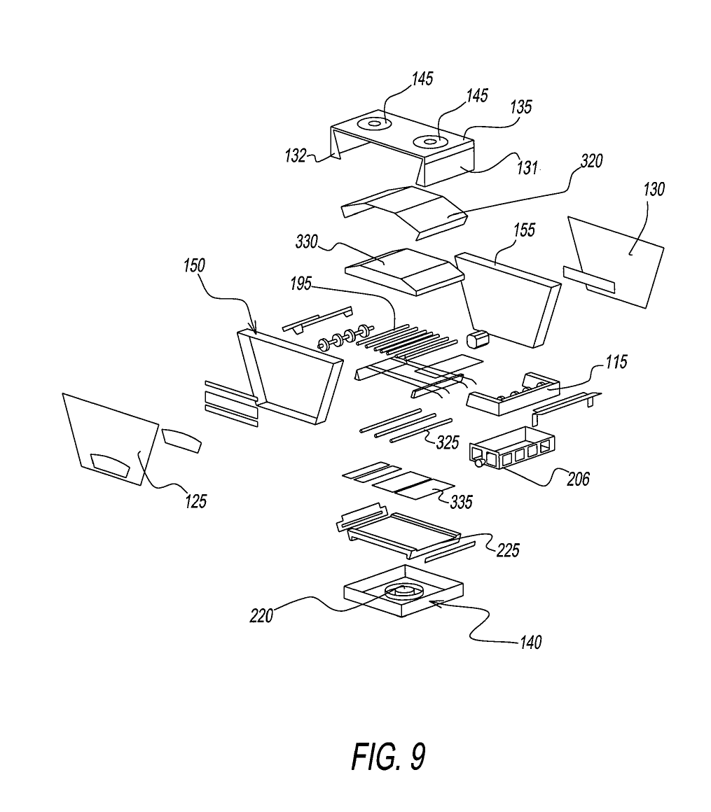

Referring now to FIG. 8, second compartment 155 has a second back panel 250 surrounded by a second compartment side wall 255 forming a second compartment interior 256. Second back panel 250 has apertures 260 therethrough adjacent an edge that connects to second bottom side wall 230. Second compartment side wall 255 has an aperture 257 therethrough from second compartment interior 256 to interior volume 180 in conveyor frame 115.

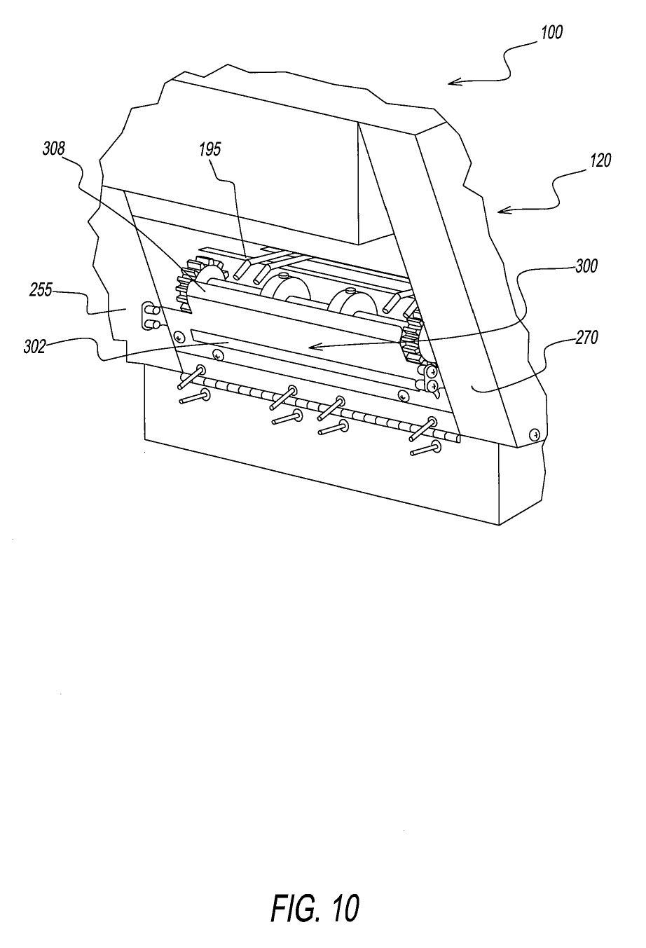

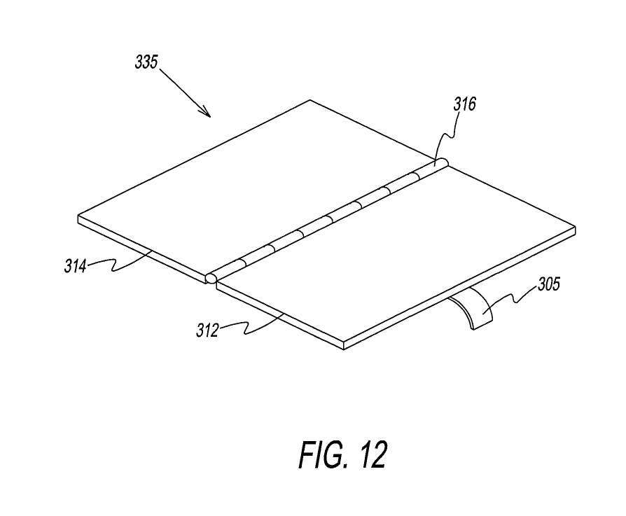

Referring now to FIGS. 10-12, an internal crumb tray 335 is disposed within a slot 303 of a scraper 300, which includes a flat sheet of metal 302 affixed to housing 120 of conveyor oven 100. Scraper 300 has an angled port 308 disposed at the top thereof and in close proximity to conveyor belt 195, just prior to belt 195 making its turn at the exit side of conveyor oven 100.

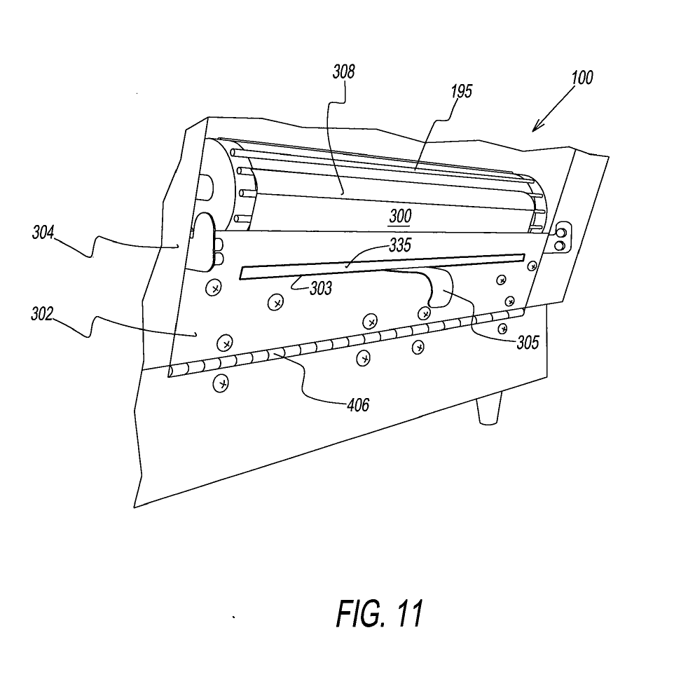

Referring to FIGS. 10 and 11, internal crumb tray 335 comprises a first flat portion 312, a second flat portion 314 and a remover tab 305. First flat portion 312 and second flat portion 314 are pivotally connected to one another via a hinge assembly 316.

In FIGS. 10 and 11, internal crumb tray 335 is installed in conveyor oven 100 via slot 303 beneath oven chamber 200 to collect cooking by-products (e.g., crumbs) that fall from conveyor belt 195 during cooking of the food products. In the fully installed position, internal crumb tray 335 is in fully extended configuration in which first and second flat portions are co-planar. In this position, only removal tab 305 is outside slot 303 of scraper 300. Internal crumb tray 335 is supported by a ledge or rail (not shown) on the interior surfaces of back panels 250 and 270.

To remove internal crumb tray 335 from conveyor oven 100, removal tab 305 is used to manually pull internal crumb tray 335 outwardly through slot 303. When hinge assembly 316 is outside slot 303, first flat portion 312 can be rotated upwardly of downwardly before sliding or pulling internal crumb tray 335 fully out of slot 303. To install internal crumb tray 335, second flat portion 314 is inserted into slot 303 and pushed until hinge assembly 316 enters conveyor oven 100. Then the operator can use tab 305 to push first flat portion 312 and internal crumb tray 335 fully into conveyor oven 100.

Hinged crumb tray 335 makes maintenance of conveyor oven 100 much more user friendly, thereby ensuring that attendants will remove and empty hinged crumb tray 335 on a periodic basis, thereby more efficiently removing of debris and allows for more reflecting of heat in the cooking chamber of conveyor oven 100, thus resulting in a better cook. Also, hinged crumb tray 335 allows it to be removed from very tight make line spaces and avoids having the service providers remove conveyor oven 100 itself from its current position. Hinged crumb tray 335 also removes items that may smell of char or other foods that might not be so appetizing.

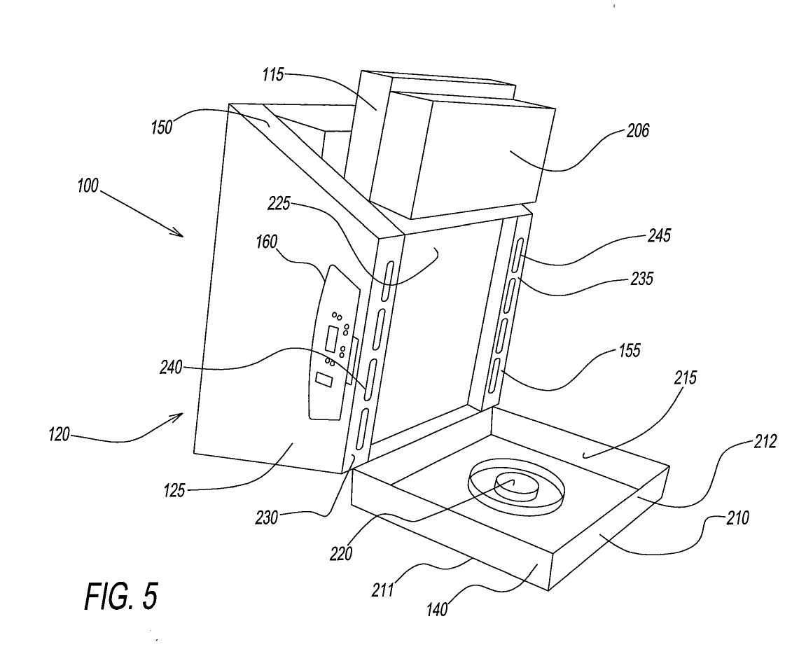

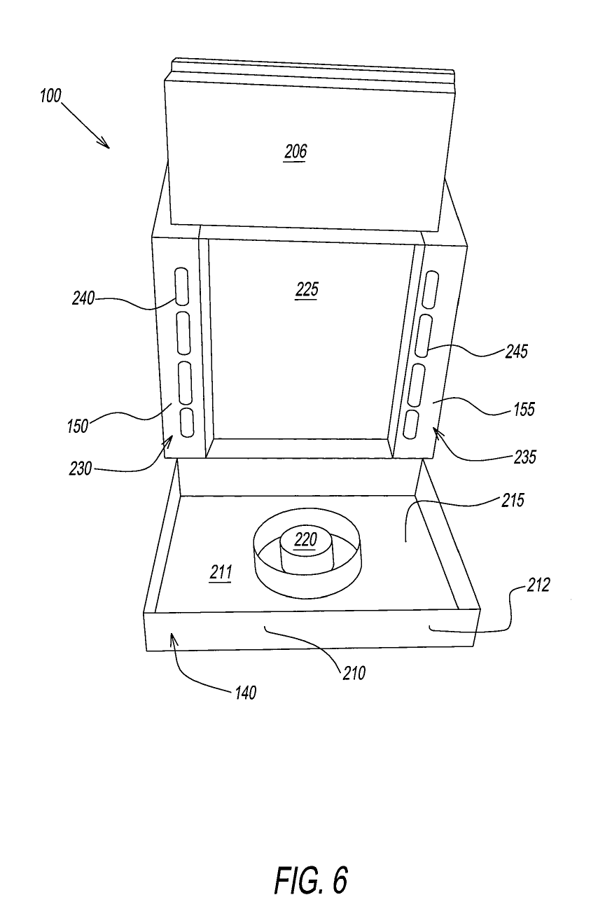

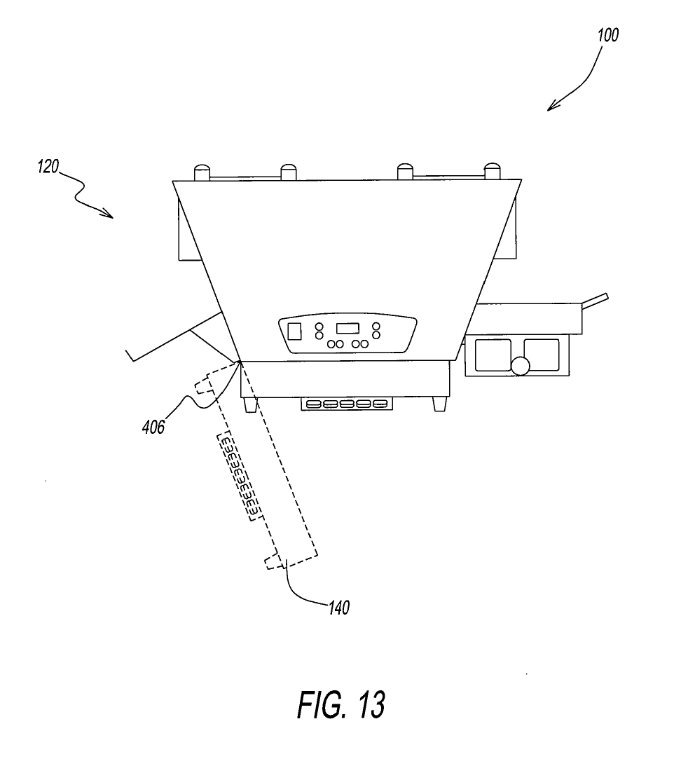

Referring to FIGS. 5, 6, 10, 11 and 13, conveyor oven 100 also comprises a hinge assembly 406 that pivotally connects housing 120 and bottom compartment 140 to one another. Thus, housing 120 can be tilted open by pivoting rearward to allow a service provider access the internals of housing 120 and bottom compartment 140. Bottom compartment 140 remains stationary as shown in FIGS. 5 and 6 on a make line work platform (not shown) when housing 120 is tilted rearward. In the tilted position most of the critical components are exposed and accessible to a service person.

One advantage of the novel hinged oven body is serviceability. That is the oven does not have to be removed from its current location to be worked on and it also helps save the service provider from getting hurt when trying to move the oven from its location during servicing.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A conveyor oven comprising:
a housing defining an oven chamber;
a conveyor that extends through said inlet into said oven chamber and that comprises a conveyor belt driven to transport food product into said oven chamber; and
a member that is configured with said housing and that is rotatable about a pivot to provide access for maintenance.

2. The conveyor oven of claim 1, wherein said member is selected from the group consisting of: a crumb tray and a bottom portion.

3. The conveyor oven of claim 2, wherein said crumb tray comprises a first flat portion and a second flat portion that are rotatable about said pivot.

4. The conveyor oven of claim 3, wherein said first flat portion and said second flat portion are co-planar when said crumb tray is fully installed in said housing, and wherein said crumb tray further comprises a handle extending from said first flat portion to assist in removal and installation of said crumb tray in said housing by rotation about said pivot of said first flat portion away from or toward said second flat portion.

5. The conveyor oven of claim 3, wherein said crumb tray further comprises a hinge assembly attached to said first and second flat portions for rotation about said pivot.

6. The conveyor oven of claim 2, wherein said housing comprises a slot and a tray support, and wherein said crumb tray is configured with said housing via said slot and said tray support.

7. The conveyor oven of claim 2, wherein said bottom portion is attached to said housing at said pivot so that either said housing or said bottom portion can be rotated about said pivot between a closed position and an access position, wherein said housing and bottom portion are flush with one another in said closed position and are apart from one another in said access position.

8. The conveyor oven of claim 2, further comprising a hinge assembly attached to said housing and said bottom portion for rotation about said pivot.

9. The conveyor oven of claim 2, further comprising parts that require maintenance, and wherein said parts are disposed in said bottom portion.

10. A method for a conveyor oven comprising:
providing a housing defining an oven chamber in said conveyor oven and at least one member of said conveyor oven that is configured with said housing; and
rotating at least one of said member and said housing about a pivot to provide access for maintenance.

11. The method of claim 10, wherein said member is selected from the group consisting of: a crumb tray and a bottom portion.

12. The method of claim 11, wherein said crumb tray comprises a first flat portion and a second flat portion that are rotatable about said pivot.

13. The method of claim 12, wherein said first flat portion and said second flat portion are co-planar when said crumb tray is fully installed in said housing, and wherein said crumb tray further comprises a handle extending from said first flat portion to assist in removal and installation of said crumb tray in said housing by rotation about said pivot of said first flat portion away from or toward said second flat portion.

14. The method of claim 12, wherein said crumb tray further comprises a hinge assembly attached to said first and second flat portions for rotation about said pivot.

15. The method of claim 11, wherein said housing comprises a slot and a tray support, and wherein said crumb tray is configured with said housing via said slot and said tray support.

16. The method of claim 11, wherein said bottom portion is attached to said housing at said pivot so that either said housing or said bottom portion can be rotated about said pivot between a closed position and an access position, wherein said housing and bottom portion are flush with one another in said closed position and are apart from one another in said access position.

17. The method of claim 11, further comprising a hinge assembly attached to said housing and said bottom portion for rotation about said pivot.

18. The method of claim 11, further comprising parts that require maintenance, and wherein said parts are disposed in said bottom portion.
